(19) United States
(12) Patent Application Publication
(10) Pub. No.: US 2001/0022321 A1
(43) Pub. Date: Sep. 20, 2001

(54) Melt flow mixer in an injection molding system

(76) Inventor: Abdeslam Bouti, Swanton, VT (US)

Correspondence Address: HUSKY INJECTION MOLDING SYSTEMS, INC, 288 NORTH ROAD, MILTON, VT, 05468, US

(21) Appl. No.: 09/822,537

(22) Filed: Mar. 30, 2001

Related U.S. Application Data
(63) Continuation-in-part of application No. 09/605,763, filed on Jun. 28, 2000.
Application No. 09/605,763 is a continuation-in-part of application No. 09/435,965, filed on Nov. 8, 1999, now Pat. No. 6,089,468.

(51) Int. Cl. B05B 1/24; B05B 1/30

(52) U.S. Cl. 239/13; 239/128; 239/135; 239/432; 239/584

(57) ABSTRACT

A flow mixer apparatus and method in an injection molding system which transitions a flowing medium around an obstruction and/or a degree change in direction, said flowing medium exhibiting reduced stagnation points and substantially uniform flow characteristics downstream of the obstruction and/or change in direction.

### CROSS-REFERENCE TO RELATED APPLICATIONS

This is a Continuation-in-Part of co-pending application entitled “Mixer to Improve Homogeneity in Injection Molding Machines and Hot Runners”, filed Jun. 28, 2000 Ser. No. 09/605,763 which is a Continuation-in-Part of application entitled “Nozzle with Weld Line Eliminator”, now issued as U.S. Pat. No. 6,089,468, both incorporated herein by reference.

### BACKGROUND OF THE INVENTION

1. Field of the Invention

This invention relates to an apparatus and method for converting the circular flow inside a melt channel to a uniform annular flow. More specifically, this invention relates to an apparatus and method for improving uniform melt flow and elimination of stagnation points as it passes through an injection molding system and/or hot runner system.

2. Summary of the Prior Art

The large number of variables in the injection molding process creates serious challenges to creating a uniform and high quality part. These variables are significantly compounded within multi-cavity molds. Here we have the problem of not only shot to shot variations but also variations existing between individual cavities within a given shot. Shear induced flow imbalances occur in all multi-cavity molds that use the industry standard multiple cavity “naturally balanced” runner system whereby the shear and thermal history within each mold is thought to be kept equal regardless of which hot-runner path is taken by the molten material as it flows to the mold cavities. These flow imbalances have been found to be significant and may be the largest contributor to product variation in multi-cavity molds.

Despite the geometrical balance, in what has traditionally been referred to as “naturally balanced” runner systems, it has been found that these runner systems can induce a significant variation in the melt conditions delivered to the various cavities within a multi-cavity mold. These variations can include melt temperature, pressure, and material properties. Within a multi-cavity mold, this will result in variations in the size, shape and mechanical properties of the product.

It is well known that providing for smooth flow of pressurized melt is critical to successful molding of certain materials. Sharp bends, corners or dead spots in the melt passage results in unacceptable residence time for some portion of the melt being processed which can cause too much delay on color changes and/or result in decomposition of some materials or pigments of some materials such as polyvinyl chloride and some polyesters or other high temperature crystalline materials. In most multi-cavity valve gated injection molding systems it is necessary for the melt flow passage to change direction by 90° and to join the bore around the reciprocating valve stem as it extends from the manifold to each nozzle.

These problems necessarily require fine tolerance machining to overcome and it is well known to facilitate this by providing a separate bushing seated in the nozzle as disclosed in U.S. Pat. No. 4,026,518 to Gellert. A similar arrangement for multi-cavity molding is shown in U.S. Pat. No. 4,521,179 to Gellert. U.S. Pat. No. 4,433,969 to Gellert also shows a multi-cavity arrangement in which the bushing is located between the manifold and the nozzle. Also shown in U.S. Pat. No. 4,705,473 to Schmidt, provides a bushing in which the melt duct in the bushing splits into two smoothly curved arms which connect to opposite sides of the valve member bore. U.S. Pat. No. 4,740,151 to Schmidt, et al. shows a multi-cavity system with a different sealing and retaining bushing having a flanged portion mounted between the manifold and the back plate.

U.S. Pat. No. 4,443,178 to Fujita discloses a simple chamfered surface located behind the valve stem for promoting the elimination of the stagnation point which would otherwise form.

U.S. Pat. No. 4,932,858 to Gellert shows a separate bushing seated between the manifold and the injection nozzle in the melt stream which comprises a melt duct with two smoothly curved arms which connect between the melt passage in the manifold and the melt passage around the valve stem in an effort to eliminate the stagnation points.

U.S. Pat. No. 5,916,605 to Swenson et al. shows an injection nozzle insert with a spiral channel formed therein. This insert is positioned adjacent the nozzle tip and requires the melt to enter through a hole at the very top of the insert. This invention therefore does not disclose a means for conveying the melt through a 90° turn as the melt transitions from the hot runner subsystem to the injection nozzle.

Referring to FIGS. 5 and 6, hot runner subsystems according to the prior art are generally shown. FIG. 5 depicts a hot runner subsystem configuration 110′ with what is commonly referred to as a valve gated nozzle. In this configuration, a heated nozzle assembly 108′ comprises a nozzle bushing 112′ sealingly abutting against a lower flange of a bushing 148′. The bushing 148′ is inserted in a bore of a hot runner manifold 138′ and directs the melt flow from melt channel 142′ through a bushing channel 144′ to a nozzle tip 128′. The bushing channel 144′ is formed internal to the bushing 148′ and directs the melt flow through a 90 degree change in flow direction. A valve stem 126′ is inserted co-axially in bushing 148′ and extends through bushing channel 144′.

As the figure shows, the melt flow goes through both a 90 degree change in direction while it also flows around the valve stem 126′. These flow disturbances result in flow imbalances and stagnation points which acts to degrade the melt. In addition, the valve stem 126′ is not adequately supported and will be subjected to wear by the often times abrasive flowing melt. It should also be noted that bushing channel 144′ is expensive and time consuming to produce.

Referring now to FIG. 6, which depicts a prior art hot runner subsystem 208′ incorporating what is commonly referred to as a “hot tip” nozzle assembly 208′. In this configuration, the valve stem and bushing have been removed. A nozzle bushing 212′ sealingly abuts directly against a lower surface of the hot runner manifold 238′. Melt channel 242′ undergoes a 90 degree change in direction to line up with the nozzle channel 220′. As the melt flows around the corner as shown by arrow A, stagnation points form at areas denoted 250′. These stagnation points impede color changing as well as degrade the melt and cause flow imbalances.

There exists a need for a method and apparatus that substantially reduces the flow imbalances and stagnation points in an injection molding system and/or hot runner system that occurs as a result of the flow being diverted through a change in direction and/or around a melt flow obstruction such as a valve stem, a nozzle, a nozzle tip, a valve stem guide, a torpedo, etc.

### SUMMARY OF THE INVENTION

The primary objective of the present invention is to provide a mixer in a melt channel that creates a substantially uniform annular flow velocity profile.

Another object of the present invention is to provide a mixer in a melt channel that eliminates stagnation points in the channel that occurs when the melt flows around an obstruction and/or a change in direction in the channel.

A further object of the present invention is to provide a means for fast color change-over in an injection molding system, thereby reducing machine downtime between color changes.

Still another object of the present invention is to provide a means for conveying heat sensitive materials through an injection molding system with reduced degradation caused by stagnation points in the melt stream.

Yet another object of the present invention is to provide substantially uniform annular flow to the mold cavity which leads to improved part quality.

Still yet another object of the present invention is to provide improved valve stem guidance and support in an injection molding machine/hot runner system, thereby resulting in a higher quality molded part and a valve stem with a longer usable life.

Yet another object of the present invention is to provide an improved, cost effective means for turning the melt flow through various angles as it flows from the machine to a mold cavity.

Still another object of the present invention is to provide a means for improving melt homogeneity as it flows through an injection molding system.

The foregoing objects are achieved by providing a mixer located in a melt channel of an injection molding system, preferably around a valve stem or other flow obstruction, where the melt navigates a change in flow direction and flows around the obstruction. One preferred embodiment comprises a cylindrically tapered insert with a helical or spiral groove disposed on its outer surface. The groove is formed to be decreasing in depth and width, so as the melt flows into the groove, it gradually spills out of the groove. As the melt travels through the helical groove, it is mixed and changes direction in the hot runner manifold. The helical groove helps direct the melt around the back of the mixer which helps to eliminate stagnation points behind the flow obstruction while also providing uniform annular flow of the melt.

Further objections and advantages of the present invention will appear hereinbelow.

### BREIF DESCRIPTION OF THE DRAWINGS

FIG. 1 is a simplified cross-sectional view of a preferred embodiment of the present invention;

FIG. 2 is a simplified cross-sectional view of a preferred embodiment of the present invention showing a mixer housing installed in a hot runner manifold;

FIG. 3 is a simplified cross-sectional view of another preferred embodiment of the present invention;

FIG. 4 is a simplified cross-sectional views of another preferred embodiment of the present invention;

FIG. 4a is an enlarged cross-sectional view of a preferred embodiment of a mixer bushing in accordance with the present invention;

FIG. 4b is a simplified cross-sectional view of a hot tip injection nozzle in accordance with a preferred embodiment of the present invention;

FIG. 5 is a cross-sectional view of a hot runner subsystem with a valve gated nozzle in accordance with the prior art;

FIG. 6 is a cross-sectional view of a hot runner subsystem with a hot-tip nozzle in accordance with the prior art;

FIGS. 7 and 8 are cross-sectional views of a hot runner subsystem of another preferred embodiment of the present invention installed in a hot runner manifold;

FIG. 9 is a simplified cross-sectional view of a preferred embodiment of a mixer in accordance with the present invention installed in a hot runner manifold;

FIG. 10 is a cross-sectional view of an injection nozzle with a mixer bushing in accordance with a preferred embodiment of the present invention.

### DETAILED DESCRIPTION OF THE PREFERRED EMBODIMENTS

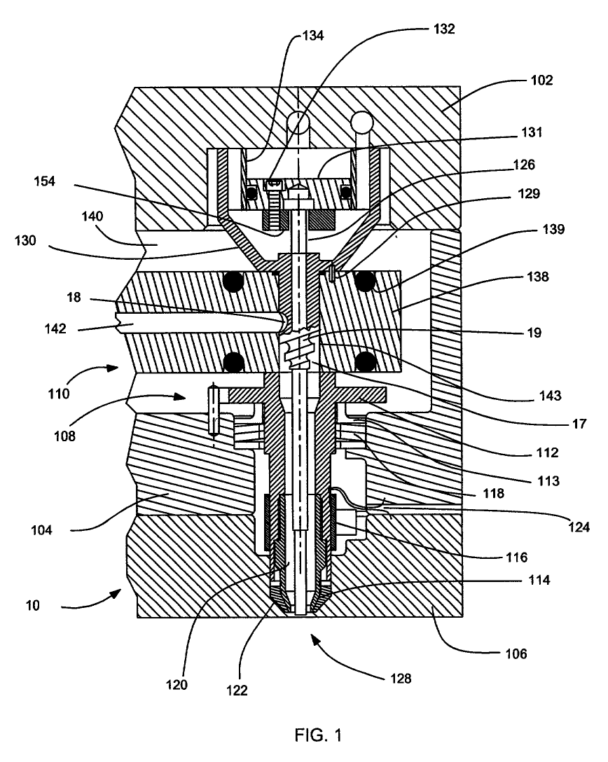

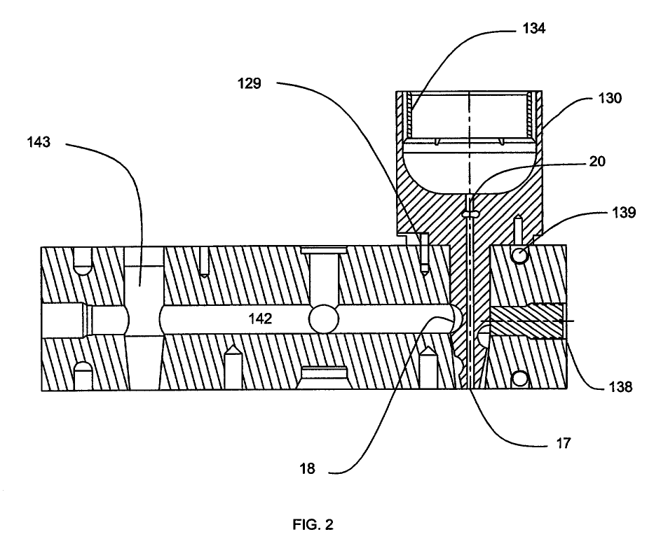

Referring first to FIG. 1, a preferred embodiment 10 in accordance with the present invention is generally shown. A hot runner valve gate system for injecting plastic material into a mold or the like is illustrated. The system includes a backing plate 102 and a manifold plate 104. A mold base 106 is further attached to the manifold plate 104.

The system further includes a nozzle assembly 108 for introducing molten plastic material into a mold (not shown) and a manifold/mixer housing arrangement 110 for communication of plastic material from a source (not shown) to the nozzle assembly 108. A manifold heater 139 is shown inserted in a manifold 138, thereby heating the manifold 138 which in turn heats the flowing plastic within a melt channel 142. The mixer housing 130 is inserted in a bore 143 of the manifold 138.

As shown in FIG. 1, the nozzle assembly 108 consists of a nozzle body 112, a tip 114, a nozzle heater 116, a spring means 118, and a nozzle insulator 113. The nozzle body 112 is typically made of steel, while the tip 114 may be formed from any suitable highly heat-conductive material known in the art such as beryllium/copper or tungsten carbide. The nozzle body 112 has an axial channel 120 through which molten plastic material flows. The tip 114 surrounds a terminal part of the axial channel 120.

If desired, the nozzle tip 114 may include a sheath 122 for thermally insulating the downstream end of the nozzle tip 114. The sheath 122 may be formed from a resinous material which may be prefabricated. Alternatively, the sheath 122 may be formed from an overflow of injected resin in the first operating cycle or cycles. The nozzle insulator 113 is installed within a cavity of the manifold plate 104 and acts to reduce the thermal communication between the nozzle body 112 and the manifold plate 104, thereby maintaining the high temperature of the molten plastic material as it flows through the axial channel 120. The nozzle insulator 113 may be formed from any suitable insulating material, typically known in the art such as titanium.

The nozzle heater 116 may be any suitable electric heater known in the art to which current is admitted by way of a cable 124. As shown in FIG. 1, the nozzle heater 116 surrounds a portion of the nozzle body 112.

A valve stem 126 is provided to permit opening and closing of the gate 128 in the nozzle body 112. The valve stem 126 may be formed by a steel rod that extends through a passageway 20 in the mixer housing 130 and into the nozzle body 112. The end of the valve stem 126 opposite to the gate 128 is connected to a piston head 131 by a set-screw 154.

The piston head 131 is housed within a cylinder housing which comprises the upper distal end of mixer housing 130 and formed by cylindrical wall 134. Downstroke of the piston head 131 causes the valve stem 126 to move into a position where it closes or reduces the cross sectional area of the gate 128 so as to restrict flow of the molten plastic material. Upstroke of the piston head 131 causes the valve stem 126 to move so as to increase flow of the molten plastic material through the gate 128.

The hot runner system of this preferred embodiment also includes the manifold/mixer arrangement 110 consisting of the manifold 138 and the mixer housing 130 inserted into bore 143 therein. A locating pin 129 fixes the alignment of the mixer housing 130 to the melt channel 142. The manifold 138 is formed by a distribution plate housed between the plates 102 and 104 but separated therefrom by an air gap 140. The backing plate 102 is rigidly affixed to the manifold plate 104 by a plurality of high strength bolts (not shown) which must withstand the large forces generated during the cyclic molding process.

The manifold includes the melt channel 142 forming part of the hot runner system for transporting molten plastic material from a source (not shown) to the gate 128 associated with a respective mold or molds. The manifold further includes the bore 143 into which mixer housing 130 is inserted. The manifold 138 may be formed from any suitable metal or heat conducting material known in the art. The manifold heater 139 is well known in the art and typically comprises a wire/ceramic resistive type heater with a cylindrical cross section that is seated into a groove of the manifold 138.

The mixer housing 130 surrounds and guides a portion of the valve stem 126. This is an important advantage of the present invention because this increased valve stem support reduces valve stem wear and will significantly increase the life of the valve stem. Increased valve stem life will result in reduced maintenance costs and machine downtime.

The mixer housing 130 is formed from any suitable material known in the art (usually steel) and is designed to be inserted into the manifold 138 from the top. As shown in FIG. 1, a helical channel 19 mates with the melt channel 142 in the manifold 138 and the axial channel 120 in the nozzle assembly 108.

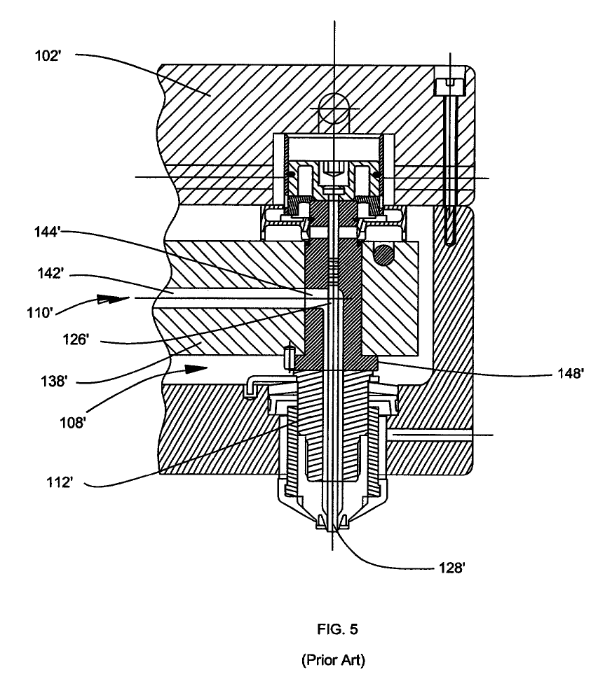

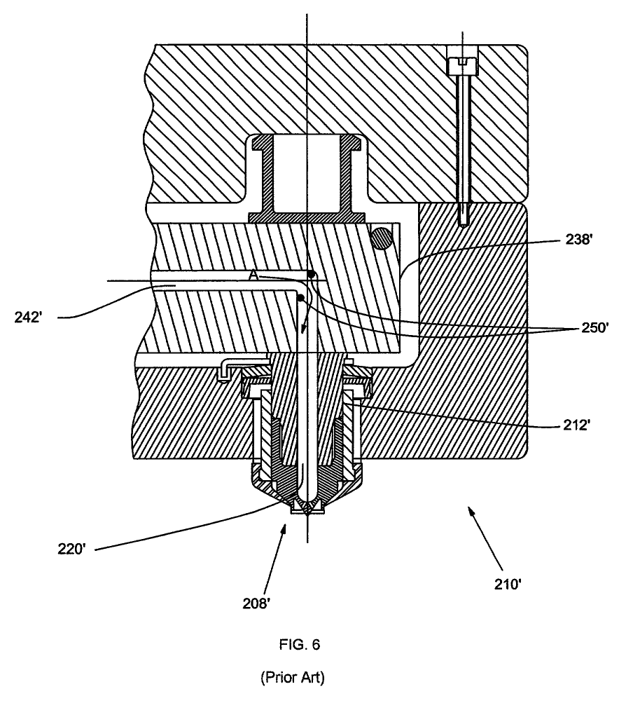

As the melt flows from melt channel 142 to a flow inlet 18, it strikes the helical channel 19 substantially perpendicular to valve stem 126 longitudinal axis. If helical channel 19 were not present, the melt would tend to flow mainly down along the face of the valve stem 126, thereby causing stagnation points behind the valve stem 126. As a result of stagnation points, parts would not fill uniformly and the melt would degrade due to prolonged exposure to elevated temperatures. However, in this preferred embodiment, the melt flows into helical channel 19 and is directed to flow around the mixer housing 130, thereby eliminating the formation of stagnation points behind the valve stem 126. As the melt flows through helical channel 19, the cross-sectional area of the groove decreases so as to force more and more of the melt out of the helical channel 19. This gradually transitions the flow to annular flow so that by the time the melt reaches an exit 17, stagnation points have been eliminated and a substantially uniform velocity profile has been established which results in the formation of high quality molded parts. In addition, the helical channel 19 has transitioned the flow through a 90° turn without the need for expensive bushings that are currently used in the art (FIG. 5).

Referring now to FIG. 2 (where like features have like numerals), another preferred embodiment in accordance with the present invention is generally shown installed in a hot runner manifold 138. In this embodiment, the mixer housing 130 is a singular bushing that is inserted in the bore 143 of the manifold 138 from the top. In this embodiment, the bore 143 is tapered at its lower end. The angle of the taper of the bore 143 is such that the gap between the bore surface and the helical channel 19 increases as the melt flows toward the exit 17. The mixer housing 130 further comprises the passageway 20 for insertion of the valve stem (not shown). The flow inlet 18 is aligned with the melt channel 142 by locating pin 129.

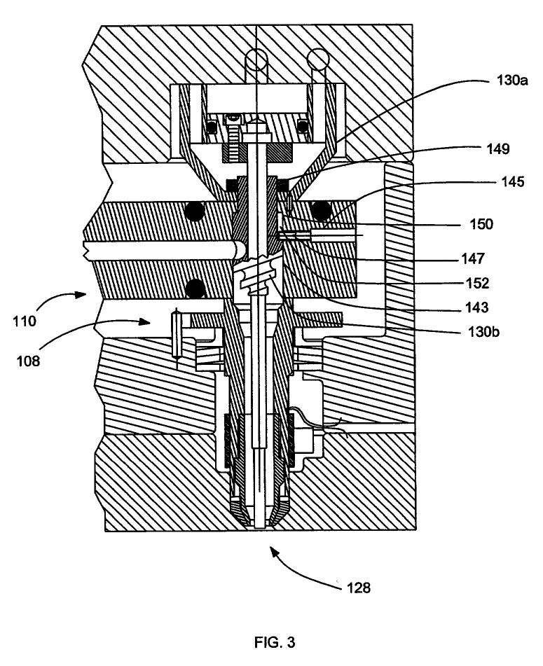

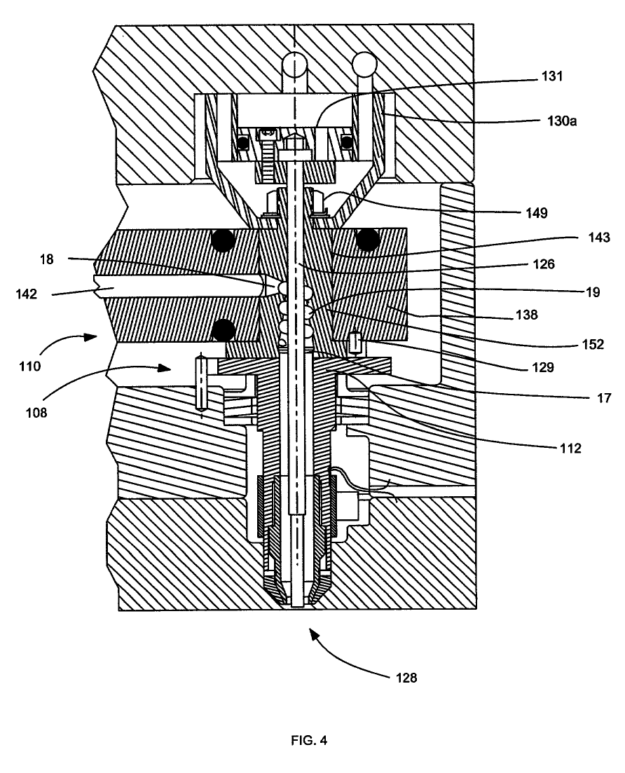

Referring now to FIG. 3, an alternate preferred embodiment of the present invention is shown where the mixer housing 130 is divided into two distinct pieces, a piston housing 130a and a mixer insert 130b. In this embodiment, the mixer insert 130b is installed in the hot runner manifold 138 from the bottom and bore 143 has a shoulder 150 where the insert 130b will seat. The piston housing 130a is installed over the top distal end of the insert 130b and a fastener 149 securely fastens the assembly as shown. A slot 152 in the insert 130b interfaces with an alignment device 147 that is installed in a hole 145 located in manifold 138. This feature maintains alignment of flow inlet 18 to the melt channel 142. This alignment feature is subject to many modifications that become apparent to one familiar with this art. For example without limitation, any type of alignment feature such as a key and keyway, or a D-shaped hole on either the mixer insert 130a or the manifold 138 could be employed.

In this embodiment, the valve stem 126 is inserted through the mixer insert 130a, thereby supporting and guiding the valve stem 126 while also directing the melt through a 90 degree turn and around the back of the valve stem 126. The helical channel 19 mixes the melt and converts the melt from circular to annular flow, thereby creating a substantially homogeneous melt exhibiting a uniform velocity profile at the exit 17.

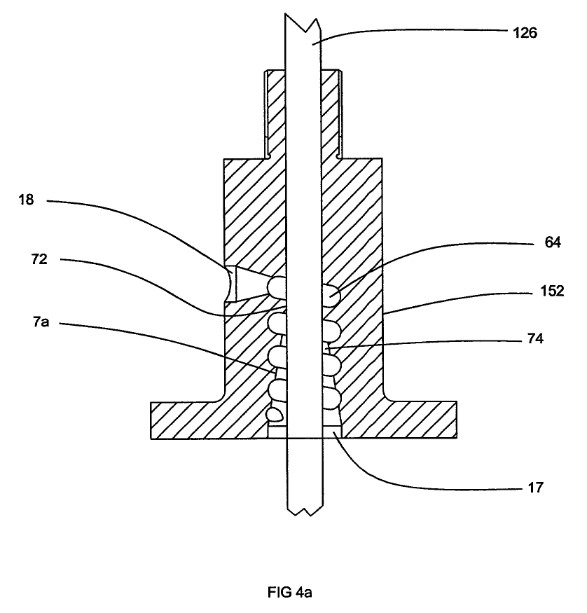

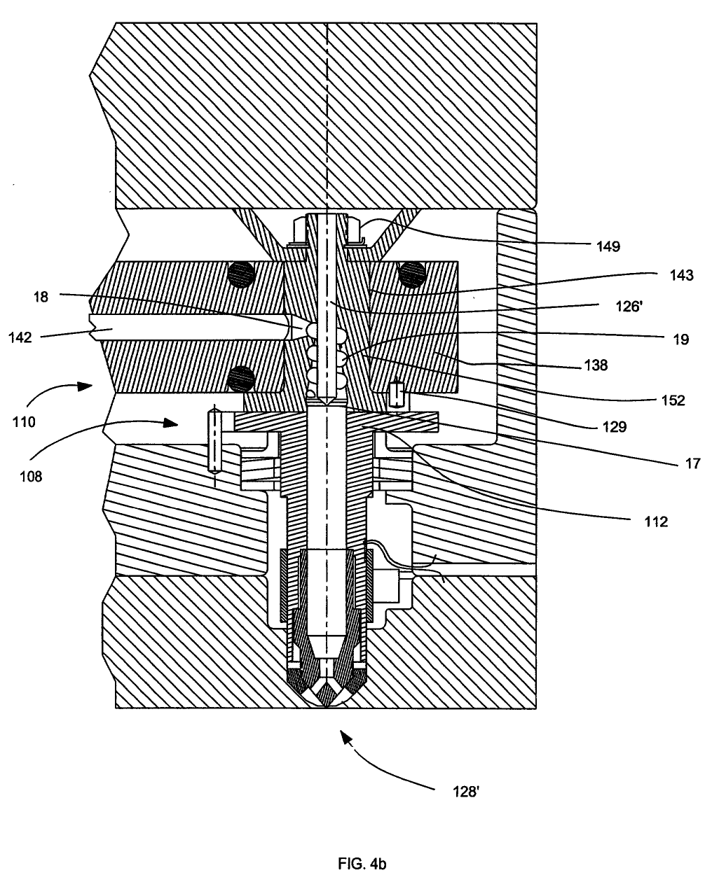

Referring now to FIGS. 4 and 4a (where like features have like numerals), another preferred embodiment in accordance with the present invention is generally shown installed in a hot runner manifold 138. A mixer bushing 152 is inserted in the bore 143 from the bottom of the manifold 138 and securely affixed therein by fastener 149. The mixer bushing 152 further comprises a flow inlet 18 and a flow exit 17 and an internal helical channel 64 communicating the melt flow therethrough. The valve stem 126 is inserted co-axially with the helical channel 64 such that the melt flow is directed around the valve stem. Mixer bushing 152 acts as a guide for valve stem 126 where the valve stem is contacted by lands 70 at contact area 72. Downstream of the contact area 72, the contact ceases as the helical channel 64 depth decreases and land clearance 74 from the valve stem steadily increases in the direction of the melt flow.

In operation, when the valve stem 126 is retracted by piston 131, the melt flows from melt channel 142 onto one or more of the helical channels 64 which induces a helical flow pattern. As the melt flow progresses toward exit 18 more and more of the melt spills over the lands 70 as the land clearance 72 gradually increases. In this manner, the helical flow is gradually transitioned to substantially uniform annular flow around the valve stem 126. Additionally, the melt flow has also undergone a change of direction of at least 90 degrees without the creation of preferential flow which has also been known to degrade molded part quality.

Referring to FIG. 4b, where like features have like numerals, an injection nozzle provided with a hot tip 128′ configuration is shown. In this embodiment, the elongated valve stem has been removed and replaced by a shortened pin 126′ which extends from the top of fastener 149 to adjacent exit 17. The mixer bushing 152 is identical to the one described in FIGS. 4 and 4a. The pin 126′ is secured by either a press fit or other suitable means, and is fixed inside the mixer bushing 152. In this configuration, an improved hot tip injection nozzle is provided wherein flow imbalances and stagnation points in the melt stream have been substantially removed.

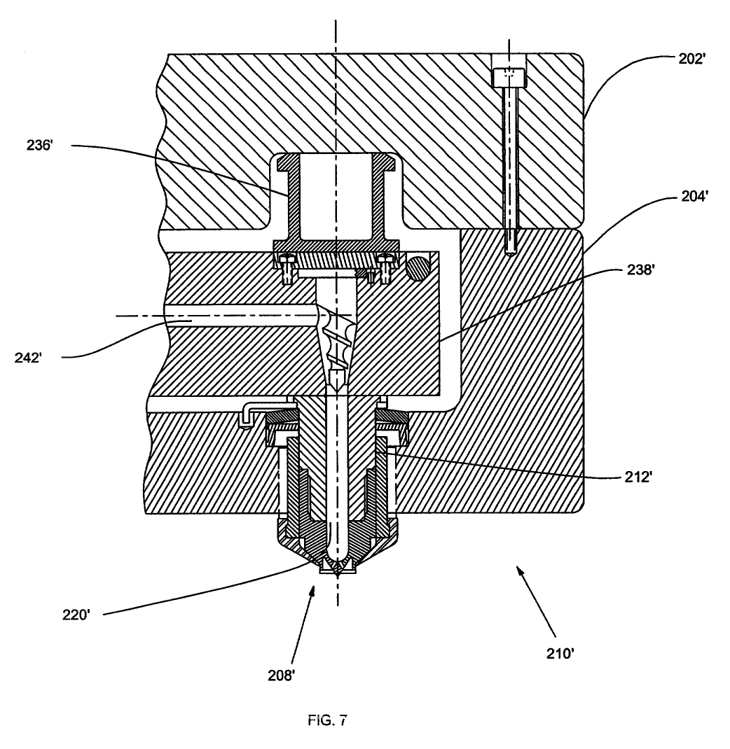

Referring now to FIG. 7, where like features have like numerals, another preferred embodiment of the present invention is shown. A mixer housing 130 is inserted in a hot runner manifold 238′ that directs the melt flow to a “hot tip” injection nozzle assembly 208′. The mixer housing 130 has a tapering helical channel 64 formed thereon, with a flow inlet 18 aligned with melt channel 242′ by locating pin 129. A cover 154 is fastened to the manifold 238′ using a plurality of fasteners 156 to affix the mixer housing 130 in the manifold. While the figure shows the mixer housing 130 and the cover 154 as separate pieces, combining these pieces is also contemplated. Similar to previously discussed embodiments, lands 70 are formed in a tapered fashion so that the gap 74 between the mixer bushing 130 and the manifold 238′ gradually increases. In operation, the melt flows from melt channel 242′ to flow inlet 18 where it enters the helical channel 64. As the melt flows through the helical channel, more and more melt spills into gap 74 such that the melt flow has undergone significant mixing and a change in direction without the creation of stagnation points.

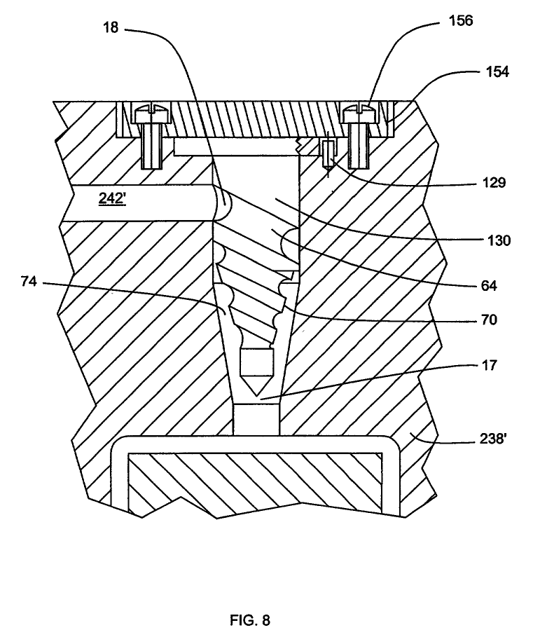

Referring to FIG. 8, where like features have like numerals, the mixer housing 130 is shown installed upstream in a hot runner manifold 238′. In this embodiment, mixer housing 130 prevents the creation of stagnation points that commonly occur inside the melt channels of a hot runner as the melt undergoes a change in direction.

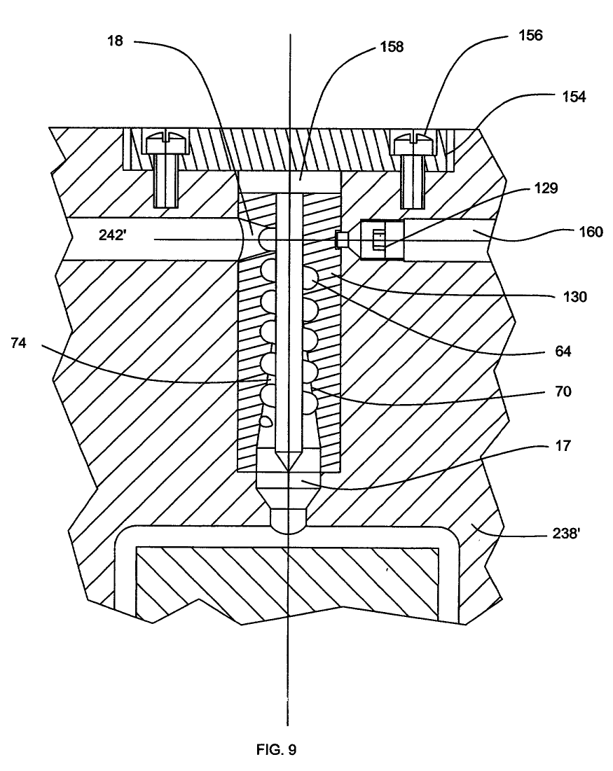

Referring now to FIG. 9, where like features have like numerals, a mixer bushing 130 is installed in a manifold 238′ in accordance with an alternative embodiment of the present invention. In this embodiment, the mixer bushing 130 has an internally formed helical channel 64 with a coaxially extending elongated headed pin 158 inserted therein. The pin and the bushing are seated in a counter bore in the manifold 238′. The mixer and pin are trapped in the manifold by a cover 154 and at least one fastener 149. A locating pin 129 is inserted in the manifold 238′ and is received by the mixer bushing 130 for maintaining alignment of the flow inlet 18 with the melt channel 242′. In this configuration, flowing melt enters flow inlet 18 from melt channel 242′ and travels down the mixer bushing 130 through helical channel 64. A gradually expanding gap 74 is created between a series of lands 70 and the pin 158. As the melt flows through the helical channel, more and more of the melt is allowed to spill over the lands 70 and into the gap 74 such that the melt flow is converted from helical to annular flow. This gradual transition substantially reduces stagnation points and increases melt homogeneity.

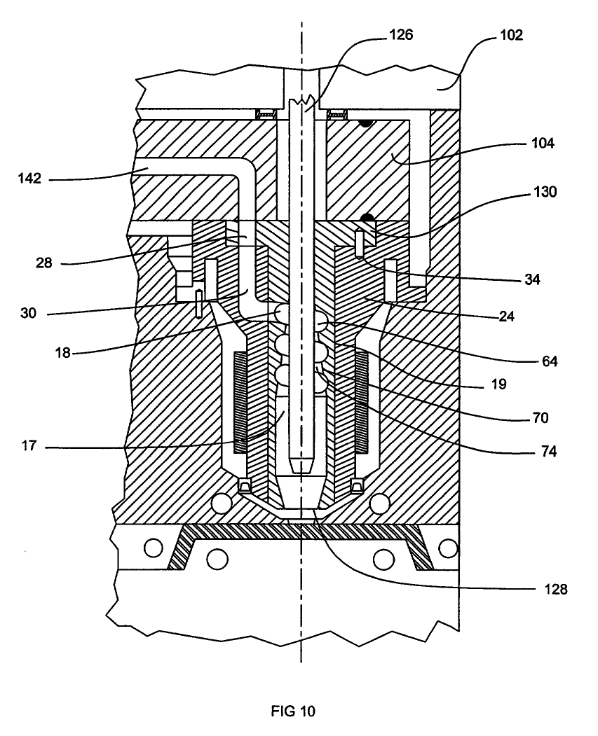

Referring now to FIG. 10, where like features have like numerals, an injection nozzle assembly in accordance with a preferred embodiment of the present invention is generally shown. A mixer bushing 130 is inserted co-axially into a nozzle housing 24 with a locator pin 34 maintaining alignment between the parts. As in previous embodiments, an internal helical channel 64 having an inlet 18 and an exit 17 is formed in the mixer bushing 130 and a movable elongated valve stem 126 extends through the helical channel to a nozzle outlet 128. A melt channel 142 in the manifold 104 is in fluid communication with a passageway 28 in the mixer bushing 130 and then a second passageway 30 formed in nozzle housing 24. The flowing melt enters the inlet 18 substantially perpendicular to the longitudinal axis of valve stem 126 and is directed into the helical channel 64. As the melt flows through the helical channel 64, more and more of it will spill over the lands 70 into gap 74 thereby gradually transitioning the melt from helical to annular flow and improving melt homogeneity.

It is to be understood that the invention is not limited to the illustrations described herein, which are deemed to illustrate the best modes of carrying out the invention, and which are susceptible to modification of form, size, arrangement of parts and details of operation. The invention is intended to encompass all such modifications, which are within its spirit and scope as defined by the claims.

What is claimed is:

1. In an injection molding system, a flow mixer in the stream of a flowing melt comprising:
a mixer housing inserted in a bore of a hot runner manifold;
a valve stem slidably inserted in said mixer housing, said valve stem being operatively connected to a piston at a top distal end and terminating adjacent a nozzle outlet at a bottom distal end;
a helical channel formed on an outside surface of said mixer housing, said helical channel communicating said flowing melt from a melt channel of said hot runner manifold to a flow exit, said flow exit being approximately perpendicular to said melt channel;
wherein said flowing melt is transitioned from circular flow to annular flow as it travels from said melt channel to said exit.

2. The flow mixer of claim 1, wherein said helical channel reduces in cross-sectional area as the melt flows from said melt channel to said exit.

3. The flow mixer of claim 1 wherein said outside surface of said mixer housing is tapered.

4. The flow mixer of claim 3, wherein said bore is tapered and a gap between said helical channel and said bore increases in the direction of said exit.

5. The flow mixer of claim 1 wherein said bore is tapered.

6. The flow mixer of claim 1, wherein said valve stem is slidably and sealingly inserted co-axially in said mixer housing and operatively positioned by said piston to start and stop the flow of said melt through said nozzle outlet.

7. The flow mixer of claim 1, wherein said helical channel is formed on the outside surface of said valve stem.

8. The flow mixer of claim 1, further comprising a locating pin for maintaining alignment of said helical channel to said melt channel.

9. The flow mixer of claim 1, further comprising a piston housing rigidly affixed to said mixer housing, said piston operative inside said piston housing to move said valve stem in an up and down motion.

10. In an injection molding system, a flow mixer comprising:
a hot runner manifold affixed between a manifold plate and a backing plate for the communication of a flowing medium to at least one nozzle assembly by at least one melt channel;
at least one mixer housing inserted into a bore of said manifold, said mixer housing further comprising:
a flow inlet in alignment with said melt channel for the communication of said medium to a flow exit;
a helical channel having a reducing cross-sectional area in the direction of travel of said melt, located between said inlet and exit, said exit being approximately perpendicular to said melt channel;
a valve stem operatively extending through said mixer housing to a nozzle outlet of said nozzle assembly, said valve stem controlling the flow of said melt.

11. The flow mixer of claim 10, further comprising a piston affixed to said valve stem for the selectable movement of said valve stem to an opened and closed position.

12. The flow mixer of claim 11, further comprising a heater in thermal communication with said nozzle assembly.

13. The flow mixer of claim 12, further comprising a locating pin for maintaining the proper alignment of said helical channel with said melt channel.

14. The flow deflector of claim 13, further comprising a spring means in communication with said nozzle assembly for urging said nozzle assembly against said manifold.

15. In an injection molding system, a method for transitioning a melt flow around an obstruction and a change in flow direction comprising the steps of:
providing a flow inlet;
providing a flow exit which is at a predetermined angle relative to said flow inlet;
positioning at least one mixer housing with a helical channel therein between said inlet and said exit, said helical channel decreasing in cross-sectional area and directing the flow of said melt around said mixer housing such that the melt exhibits substantially uniform flow velocity and a substantial reduction of stagnation points when said melt reaches said flow exit.

16. The method of claim 15, further comprising the steps of:
providing a valve stem slidably inserted into said mixer housing and operatively positioned to start and stop the flow of said medium.

17. The method of claim 15, wherein said mixer housing is tapered.

18. The method of claim 15, wherein said helical channel is formed on said valve stem.

19. In an injection molding system, a flow mixer in the stream of a flowing melt comprising:
a mixer bushing inserted in a bore of a hot runner manifold;
a valve stem slidably inserted in said mixer bushing, said valve stem being operatively connected to a piston at a top distal end and terminating adjacent a nozzle outlet at a bottom distal end;
a helical channel formed on an inside surface of said mixer bushing, said helical channel communicating said flowing melt from a melt channel of said hot runner manifold to a flow exit, said flow exit being approximately perpendicular to said melt channel;
wherein said flowing melt is transitioned from circular flow to annular flow as it travels from said melt channel to said exit.

20. The flow mixer of claim 19, wherein said helical channel reduces in cross-sectional area as the melt flows from said melt channel to said exit.

21. The flow mixer of claim 19 wherein said inside surface of said mixer housing is tapered such that the gap between said helical channel and said inside surface is gradually increasing in the direction of the melt flow.

22. The flow deflector of claim 19, wherein said valve stem is slidably inserted co-axially in said mixer bushing and operatively positioned by said piston to start and stop the flow of said melt through said nozzle outlet.

23. The flow mixer of claim 19, further comprising a locating pin for maintaining alignment of said helical channel to said melt channel.

24. The flow mixer of claim 19, further comprising a piston housing rigidly affixed to said mixer bushing, said piston operative inside said piston housing to move said valve stem in an up and down motion.

25. In an injection molding system, a flow mixer in the stream of a flowing melt comprising:
a mixer bushing inserted in a bore of a hot runner manifold;
a helical channel formed on an outside surface of said mixer bushing, said helical channel communicating said flowing melt from a melt channel of said hot runner manifold to a flow exit, wherein said flow exit causes a predetermined change in flow direction as said flowing melt travels from said melt channel to said flow exit;
wherein the formation of stagnation points has been substantially reduced.

26. The flow mixer of claim 25 wherein said mixer bushing is tapered.

27. The flow mixer of claim 25 wherein said bore is tapered.

28. The flow mixer of claim 25 wherein said mixer bushing and said bore is tapered.

29. The flow mixer of claim 28 wherein a gap between said bore and said mixer bushing gradually increases as the melt travels from said flow inlet to said exit.

30. The flow mixer of claim 25 further comprising a cover and a plurality of fasteners rigidly affixing said mixer bushing to said hot runner manifold.

31. The flow mixer of claim 25 wherein said exit communicates said flowing melt to an injection molding nozzle.

32. The flow mixer of claim 31 wherein said injection molding nozzle is a hot tip nozzle.

33. The flow mixer of claim 25, further comprising a locating pin for maintaining alignment of said melt channel to said helical channel.

34. The flow mixer of claim 25, wherein said helical channel gradually decreases in cross-sectional area as said melt travels through said helical channel.

35. In an injection molding system, a flow mixer in the stream of a flowing melt comprising:
a mixer bushing inserted in a bore of a hot runner manifold;
a helical channel formed on an inside surface of said mixer bushing, said helical channel communicating said flowing melt from a melt channel of said hot runner manifold to a flow exit, wherein said flow exit exhibits a predetermined change in flow direction as said flowing melt travels from said melt channel to said flow exit;
a pin inserted co-axially in said helical channel which at least initially directs substantially all of the flowing melt into said helical channel;
wherein the flowing melt exhibits substantially uniform cross-sectional velocity and the formation of stagnation points has been substantially reduced when the flowing melt reaches said exit.

36. The flow mixer of claim 35 wherein a gap between said helical channel and said pin gradually increases as the melt travels from said flow inlet to said exit.

37. The flow mixer of claim 35 wherein said exit communicates said flowing melt to an injection molding nozzle.

38. The flow mixer of claim 37 wherein said injection molding nozzle is a hot tip nozzle.

39. The flow mixer of claim 35, further comprising a locating pin for maintaining alignment of said melt channel to said helical channel.

40. The flow mixer of claim 35, wherein said helical channel gradually decreases in cross-sectional area as said melt travels through said helical channel.

41. The flow mixer of claim 35 further comprising a cover and a plurality of fasteners rigidly affixing said mixer bushing to said hot runner manifold.

42. In an injection molding system having a heated hot runner manifold with a primary melt channel formed therein, an injection nozzle comprising;
a mixer bushing having a helical channel with a flow inlet and an exit formed therein;
a nozzle body having a melt channel formed therein and co-axially located around said mixer bushing, said melt channel in fluid communication with said flow inlet and said primary melt channel in fluid communication with said melt channel;
a movable valve stem inserted co-axially in said helical channel for selectably starting and stopping a flowing melt.

43. The injection nozzle of claim 42, wherein a gap between said helical channel and said valve stem gradually increases as the melt travels from said flow inlet to said exit.

44. The injection nozzle of claim 42, wherein a melt passageway in said mixer bushing is located between said primary melt channel and said melt channel.

45. The injection nozzle of claim 42, further comprising a locator affixed between said nozzle housing and said mixer bushing thereby maintaining the alignment of said melt channel to said flow inlet.
